(19) United States
(12) Patent Application Publication
(10) Pub. No.: US 2021/0259478 A1
(43) Pub. Date: Aug. 26, 2021

(54) Portable Soft Tote Shower Unit

(71) Applicants: Phillip Earl Kelly, Rancho Santa Fe, CA (US); Christopher Jackson Crawford, Carlsbad, CA (US)

(72) Inventors: Phillip Earl Kelly, Rancho Santa Fe, CA (US); Christopher Jackson Crawford, Carlsbad, CA (US)

(21) Appl. No.: 17/183,073

(22) Filed: Feb. 23, 2021

Related U.S. Application Data
(60) Provisional application No. 62/981,192, filed on Feb. 25, 2020.

(51) Int. Cl. A47K 3/28; B05B 1/18

(52) U.S. Cl. CPC A47K 3/285; B05B 1/18

(57) ABSTRACT

A portable compressible shower unit is a showering device that is easy to carry around and can maintain water at a specific temperature for longer hours. In order to accomplish this, the device includes a carrier bag with straps, that provide the user the leverage to carry the shower unit and carry it around like a backpack. The device further includes an insulated water bag that can maintain the temperature of the water for long hours. Further, a battery unit included within the device helps power a pump to dispense the water from the bag to a shower head. An expandable zipper lid allows the water bag to expand and store more water. Furthermore, the device includes storage pockets to allow the user to carry and store away the hose and shower head as well as other accessories that the user may want to carry along.

The current application claims a priority to the U.S. Provisional Patent application Ser. No. 62/981,192 filed on Feb. 25, 2020.

### FIELD OF THE INVENTION

The present invention relates generally to a portable shower apparatus that comprises an insulated water bag. More specifically, the present invention is a portable shower for activities such as road trips and camping that is primarily battery-powered and helps maintain the temperature of the water within the insulated water bag.

### BACKGROUND OF THE INVENTION

When it comes to staying clean with a shower and being on the move, showering may be hard to come across. For example, when planning a road trip without access to a shower, it may be hard to efficiently clean one's body when body odor is inevitable. Another example can be an activity such as camping, as camping require people to stay outdoors for an extended period of time. One challenge that may occur in the activity of camping is the unavailability and accessibility to clean and heated water. The ability of having instant and easy access to pressurized and clean water wherever you go is always appreciated and an added advantage to such activities. In the market, there are many choices of different portable showers. However, a portable shower unit that can be maneuvered like a backpack, and which can maintain the temperature of water for long hours and provide pressurized water with a battery-operated pump are rare to come across.

An objective of the present invention is to provide users with a portable shower unit that is easy to carry around and can maintain water at a specific temperature for longer hours within a compressible insulated bag. According to the present invention, the shower unit may be maneuvered like a backpack as there are straps around the present invention which provides the user the leverage to carry the shower unit with ease and the ability to travel with the portable shower unit. The present invention further comprises of an insulated water bag that will maintain the temperature of the water within the bag. Furthermore, the present invention comprises of a battery unit that is used to help power the pump to dispense the water within the bag. Additionally, the present invention comprises an actuation switch to activate the pump that is used to dispense the water out of the bag to a shower head. An expandable zipper lid of the present invention allows the water bag to expand and store more water. The present invention further comprises storage pockets to allow the user to carry and store away the hose and shower head as well as other accessories that the user may want to carry along.

### BRIEF DESCRIPTION OF THE DRAWINGS

FIG. 1 is an isometric view of the present invention without an external carrier bag, wherein parts of the insulated water receptacle is shown in phantom.

FIG. 2 is a front elevational view of the present invention.

FIG. 3 is a rear elevational view of the present invention.

FIG. 4 is a sectional view of the present invention taken along A-A′ of FIG. 3.

FIG. 5 is a top plan view of the present invention.

FIG. 6 is a top-front left perspective view of the present invention with an external carrier, wherein the carrier bag is shown in a closed configuration.

FIG. 7 is a side view of the present invention, wherein the external carrier bag is in an open configuration and the shower head is in an extended position.

### DETAIL DESCRIPTIONS OF THE INVENTION

All illustrations of the drawings are for the purpose of describing selected versions of the present invention and are not intended to limit the scope of the present invention.

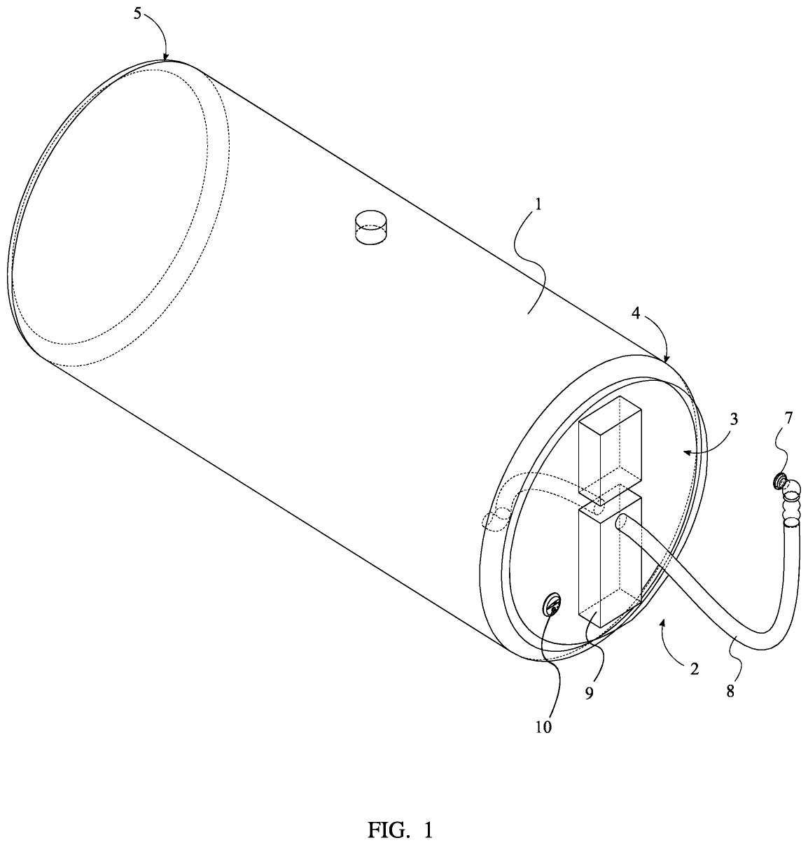

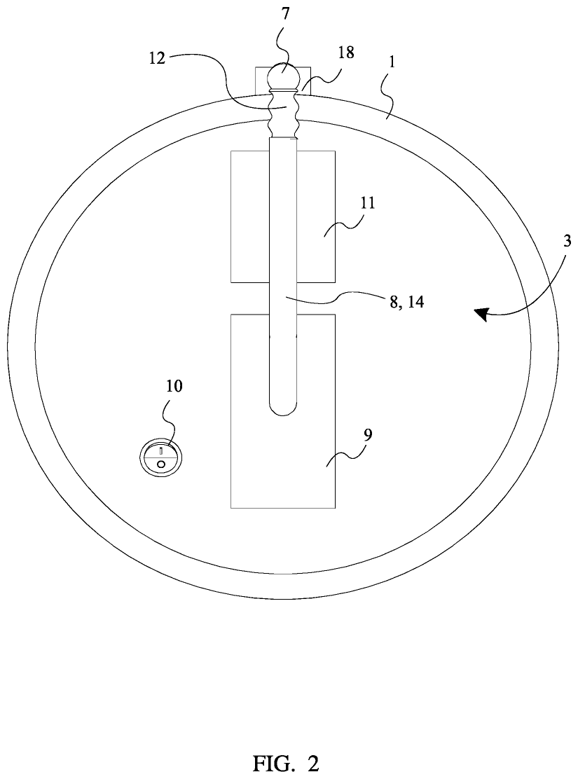

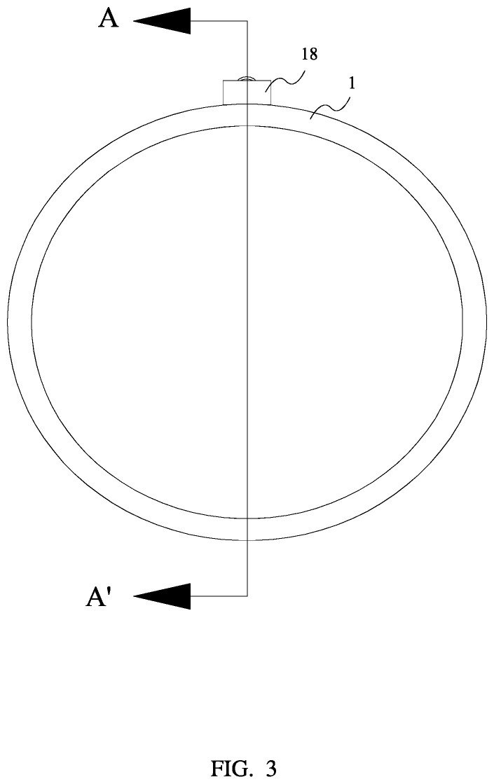

In reference to FIG. 1 through FIG. 7, the present invention is a portable collapsible shower unit. An objective of the present invention is to provide users with a portable shower unit that is easy to carry around and can maintain water at a specific temperature for longer hours within a compressible/expandable insulated bag. According to the present invention, the shower unit may be maneuvered like a backpack as there are straps around the present invention which provide the user the leverage to carry the shower unit with ease and the ability to travel with the portable shower unit. The present invention further comprises of an insulated water bag that will maintain the temperature of the water within the bag. Furthermore, the present invention comprises of a battery unit that is used to help power the pump to dispense the water from the bag. Additionally, the present invention comprises an actuation switch to activate the pump that is used to dispense the water out of the bag to a shower head. An expandable zipper lid of the present invention allows the water bag to expand and store more water. The present invention further comprises storage pockets to allow the user to carry and store away the hose and shower head as well as other accessories that the user may want to carry along.

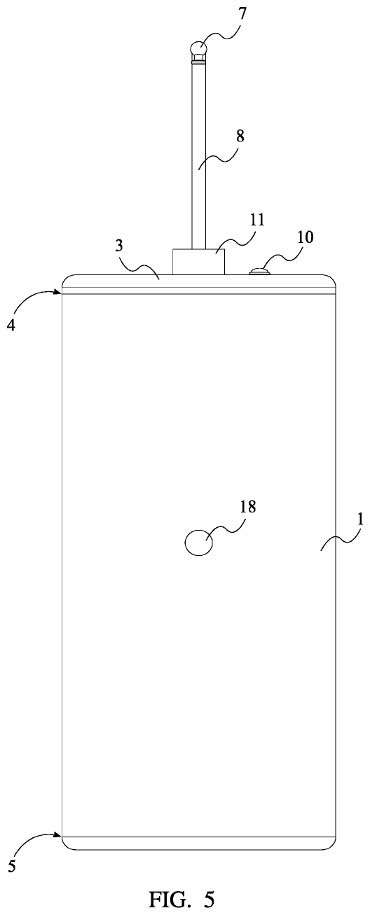

The following description is in reference to FIG. 1 through FIG. 7. As seen in FIG. 1 through FIG. 7, the portable collapsible shower unit comprises a water receptacle 1, a shower system 2, and a utility panel 3. As seen in FIG. 1, the water receptacle 1 comprises a first end 4 and a second end 5, wherein the first end 4 is positioned opposite to the second end 5 across the water receptacle 1. The water receptacle 1 intends to hold the water needed for the shower unit. In order to accomplish this, an inner cavity 6 extends from the first end 4 to the second end 5 within the water receptacle 1. Preferably, the water receptacle 1 is an insulated container with an insulation thickness of approximately 1 inch, that can keep water at the set temperature for long duration (6-8 hours). It is an aim of the present invention to provide users with a portable, compact, and lightweight shower, that is easy for transporting and taken along during a trek/hike. Accordingly, the water receptacle 1 is collapsible and expandable. Further, when the water receptacle 1 is filled to the maximum capacity, the water receptacle 1 is cylindrically shaped. However, the water receptacle 1 may comprise any shape, size, material, features, type or kind, orientation, components, and arrangements of components that would allow the present invention to fulfill the objectives and intents of the present invention. According to a preferred embodiment of the present invention, the shower system 2 comprises a shower head 7, a hose 8 and a pump 9. Preferably, the shower system 2 enables a user to access pressurized water from the water receptacle 1 through the hose 8 and the shower head 7. In order to further assist in the smooth functioning of the shower system 2, the utility panel 3 comprises an actuation button 10, and a power unit 11. As seen in FIG. 1 and FIG. 5, the utility panel 3 is mounted onto the first end 4 of the water receptacle 1. Preferably, the utility panel 3 is a solid panel that serves as a housing structure that can hold all the electrical and mechanical components in a safe and secure manner, away from the water. As seen in FIG. 1, the utility panel 3 has a circular profile, and protrudes from the first end 4 of the water receptacle, in a direction opposite to the second end 5. Thus, the first end 4 constitutes the proximal end of the portable shower unit that the user may easily access, in order to operate the shower system 2. To that end, the pump 9 is laterally integrated into the utility panel 3. Preferably, the pump 9 is operably coupled to the water receptacle 1, such that, the pump 9 induces a pressure differential that draws water from the inner cavity 6 into the shower head 7 through the hose 8. Preferably, the pump 9 is a 12V diaphragm water pump and the shower head 7 comprises an ergonomic, actuating device 12, which actuates the flow of the pressurized water through the shower head 7. Further, the hose 8 is extendible and retractable. This is so that, the user may extend the hose 8 to orient the shower head 7 according to the user's preference. However, it should be noted that the pump 9, the shower head 7 and the hose 8 may comprise any size, shape, brand or size, that is known to one of ordinary skill in the art, as long as the intended purpose of the present invention is not altered. An example of such a hose 8 includes a coiled hose, and an example of such a shower head 7 includes a sprayer with one or more spray settings.

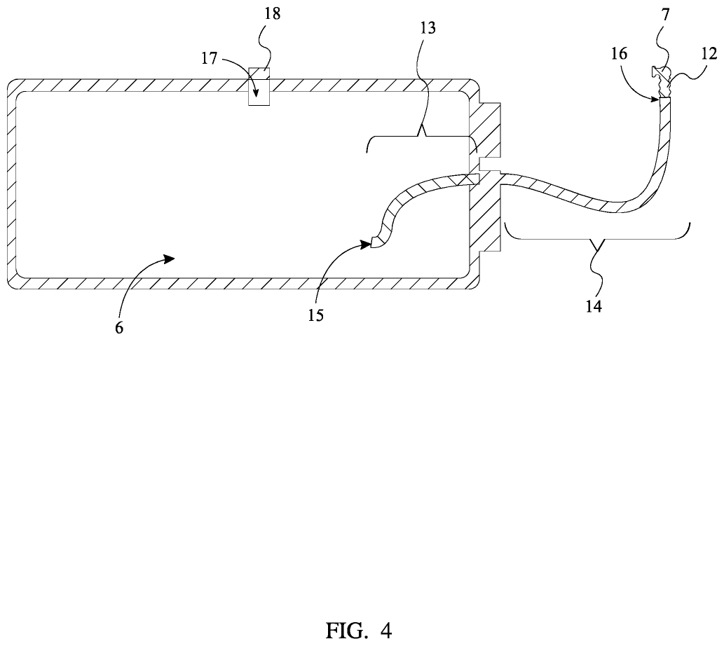

In the preferred embodiment, the hose 8 comprises a first section 13, a second section 14, a third end 15 and a fourth end 16, wherein the third end 15 is positioned opposite to the fourth end 16 across the hose 8. As seen in FIG. 4, the first section 13 is positioned within the inner cavity 6 and the second section 14 of the hose 8 is positioned outside the water receptacle 1. In order to enable the user to access water from a bottom surface of the inner cavity 6, the third end 15 of the hose 8 penetrates into the inner cavity 6. Further, the fourth end 16 is connected to the shower head 7, such that there is an uninterrupted flow of water from the water receptacle 1 into the shower head 7, through the hose 8. Furthermore, the actuation button 10 is operably coupled to the pump 9, such that operating the actuation button 10 controls pumping of water into the shower head 7. Preferably, the actuation button 10 comprises at least one on/off power button that can manually operate the water pump 9. In other words, the actuation button 10 provides user the ultimate control in the operation of the shower system 2. In order to provide power to all the electrical components of the present invention, the power unit 11 is electrically connected to the pump 9 and the actuation button 10. Preferably, the power unit 11 is a 12V rechargeable battery. However, any other powering system that is known to one of ordinary skill in the art may be used for the smooth functioning of the portable shower unit.

In an alternate embodiment, the present invention may comprise an additional heater unit that may be electrically connected to the power unit 11 and operably coupled to the water receptacle 1. The heater user is intended to heat the water within the water receptacle 1 to user defined temperatures.

In the preferred embodiment, the present invention comprises a fill hole 17 and a resealable cap 18, wherein the fill hole 17 is used for filling water in the water receptacle 1. Accordingly, the fill hole 17 traverses into the water receptacle 1, and the resealable cap 18 is engaged with the fill hole 17. Preferably the fill hole 17 and the resealable cap 18 have circular cross sections and are engaged by means of a threaded port. However, the fill hole 17 and the resealable cap 18 may comprise any shape, size, fastening mechanism, components, arrangement of components etc. that are known to one of ordinary skill in the art, as long as the intents of the present invention are not hindered.

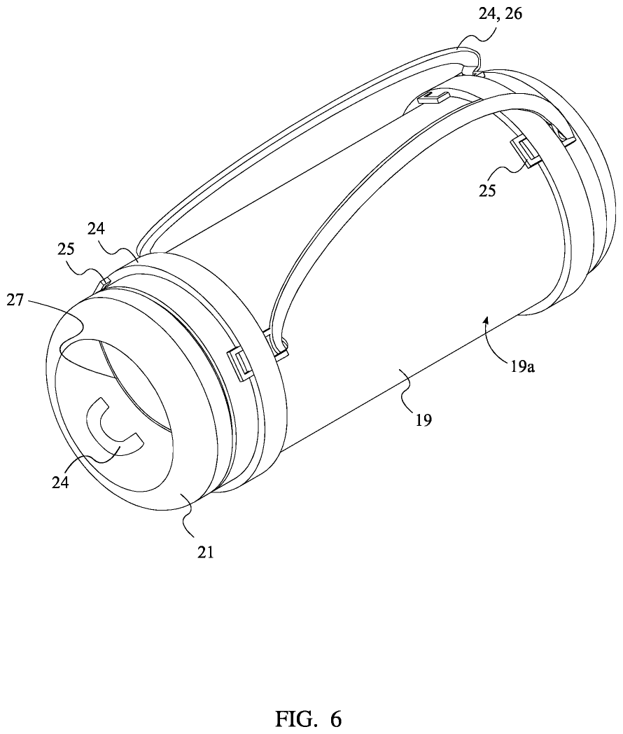

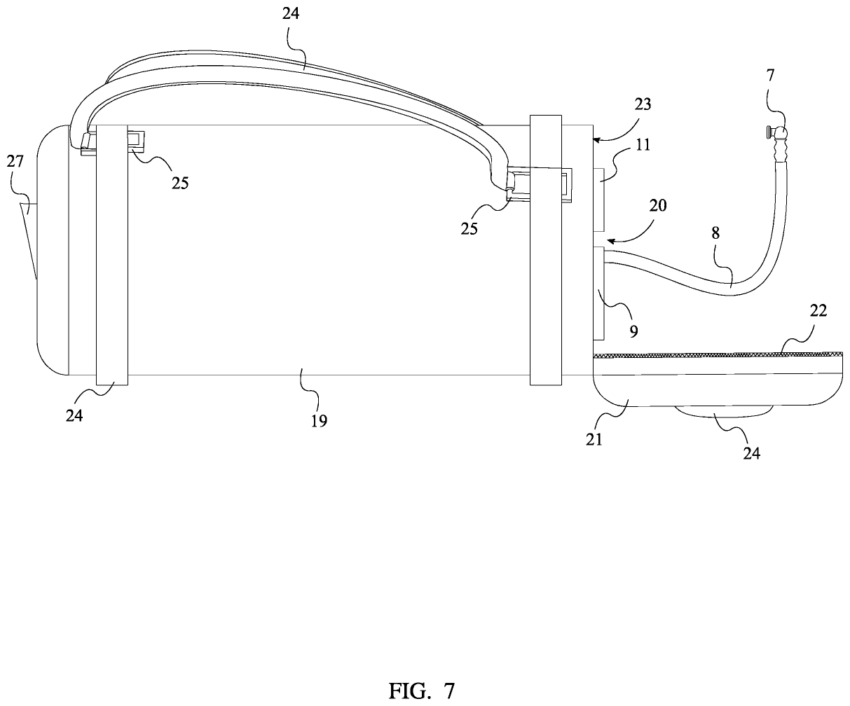

It is an aim of the present invention to provide easy carrying means, as well as a protected and insulated layer for the shower unit. In order to accomplish this, the present invention comprises a carrier bag 19. Preferably, the carrier bag 19 is a soft tote insulated bag that comprises the shape and dimensions to fit in the water receptacle 1 in a snug fashion. However, the carrier bag 19 may comprise any other material, size and shape that are known to one of ordinary skill in the art, as long as the intents of the present invention are fulfilled. The present invention further comprises a bag opening 20, wherein the bag opening 20 laterally traverses into the carrier bag 19. Preferably, the water receptacle 1 is placed within the carrier bag 19 through the bag opening 20. In other words, the bag opening 20 constitutes a main entry way for the water receptacle 1, and for accessing the utility panel 3 and the shower system 2. The resealable cap 18 may be accessed through the bag opening 20, such that the user may open the resealable cap, fill the water receptacle 1 with water, and close the resealable cap 18 through the bag opening 20. However, it should be noted that the carrier bag 19 may comprise any other number of resealable openings at different locations, as long as the intents of the present invention are not altered. Continuing with the preferred embodiment, the present invention further comprises an expandable lid 21. The expandable lid 21 is the component of the present invention that allow the user to expand the dimensions of the carrier bag 19 according to the amount of water within the water receptacle 1. As seen in FIG. 6 and FIG. 7, the expandable lid 21 is terminally connected to the carrier bag 19 adjacent to the bag opening 20. Furthermore, the present invention comprises a bag fastener 22, wherein the bag fastener 22 is integrated between an open edge 23 of the carrier bag 19 and the expandable lid 21. Preferably, the bag fastener 22 is a zipper. However, any other fastener or fastening mechanism that is known to one of ordinary skill in the art may be employed to close the bag opening 20 with the expandable lid 21. Examples of such fasteners include, but are not limited to snap clips, toggle locks, cord locks, magnetic fasteners etc.

In reference to FIG. 6, wherein the carrier bag 19 is in a closed configuration, the bag opening 20 is covered by the expandable lid 21, and the bag fastener 22 is fastened. Further, the water receptacle 1, the shower system 2, and the utility panel 3 will be enclosed within the carrier bag 19, in the closed configuration. In reference to FIG. 7, wherein the carrier bag 19 is in an open configuration, the bag fastener 22 is unfastened, and the utility panel 3 is exposed through the bag opening 20. Furthermore, in this configuration the shower head 7 and the second section 14 of the hose 8 are accessible through the bag opening 20, even though the water receptacle 1 is enclosed by the carrier bag 19.

Continuing with the preferred embodiment, the present invention comprises a plurality of straps 24 and a plurality of fasteners 25. As seen in FIG. 6 and FIG. 7, the plurality of straps 24 is laterally integrated onto an external surface 19a of the carrier bag 19, and each of the plurality of fasteners 25 is engaged with a corresponding strap 26, wherein the corresponding strap 26 is from the plurality of straps 25. Preferably, the plurality of straps 24 is backpack straps, that are used as handles and leverage to carry the present invention from one location to another. In other words, the plurality of straps 24 may include any strap attachments, that are mounted onto the external surface 19a around the cylindrical body of the carrier bag 19 by any fastening means such as being stitched on. Preferably, the plurality of fasteners 25 includes strap buckles, stiches etc. that are seen in a typical backpack, wherein the strap buckles may be used to alter the length and size of the loops created by the backpack straps to facilitate different sizes of users. However, the plurality of straps 24 and the plurality of fasteners 25 may include any other material, size, shape, components, and arrangement of components, as long as the objectives of the present invention are fulfilled.

According to the preferred embodiment, the present invention comprises a plurality of pockets 27, wherein the plurality of pockets 27 is integrated into the carrier bag 19. Preferably, the plurality of pockets 27, allows the user to store accessories needed for the trip. Further, the plurality of pockets 27 may also be used to house the hose 8 and the shower head 7. Accordingly, the plurality of pockets 27 may be positioned anywhere around the carrier bag 19 externally or internally, as long as the intents of the present invention are not altered.

In the preferred embodiment, the present invention further comprises, a one-way air bleeder valve to prevent the pump 9 from sucking in air and collapsing the water receptacle 1 as the water is pumped out. Furthermore, the present invention comprises multiple electrical and non-electrical connections between the various components of the present invention, that are needed for the smooth functioning of the device. It should also be noted that, any other similar internal components that are known to one of ordinary skill in the art, and that may be integrated into for the smooth operation of the portable shower unit, will fall under the scope of the present invention.

Although the invention has been explained in relation to its preferred embodiment, it is to be understood that many other possible modifications and variations can be made without departing from the spirit and scope of the invention as hereinafter claimed.

What is claimed is:

1. A portable collapsible shower unit comprising:
a water receptacle;
a shower system;
a utility panel;
the water receptacle comprising a first end, a second end, an inner cavity;
the shower system comprising a shower head, a hose and a pump;
the utility panel comprising an actuation button, and a power unit;
the inner cavity extending from the first end towards the second end within the water receptacle, wherein the first end is positioned opposite to the second across the water receptacle;
the utility panel being mounted onto the first end;
the pump being laterally integrated into the utility panel;
the pump being operably coupled to the water receptacle, wherein the pump induces a pressure differential that draws water from the inner cavity into the shower head through the hose;
the actuation button being operably coupled to the pump, wherein operating the actuation button controls pumping of water into the shower head; and
the power unit being electrically connected to the pump and the actuation button.

2. The shower unit of claim 1, wherein the water receptacle being compressible and expandable.

3. The shower unit of claim 1, wherein the hose comprising:
a first section, a second section, a third end, and a fourth end;
the first section being positioned within the inner cavity;
the second section being positioned outside the water receptacle;
the third end penetrating into the inner cavity; and
the fourth end being connected to the shower head, wherein the third end is positioned opposite to the fourth end across the hose.

4. The shower unit of claim 3, wherein the second section of the hose being extendible and retractable.

5. The shower unit of claim 1, comprising:
a fill hole;
a resealable cap;
the fill hole traversing into the water receptacle; and
the resealable cap being engaged with the fill hole.

6. The shower unit of claim 1, comprising:
a carrier bag;
a bag opening;
an expandable lid;
a bag fastener;
the bag opening laterally traversing into the carrier bag;
the expandable lid being terminally connected to the carrier bag adjacent to the bag opening; and
the bag fastener being integrated between an open edge of the carrier bag and the expandable lid.

7. The shower unit of claim 6, comprising:
wherein the carrier bag is in a closed configuration:
the bag opening being covered by the expandable lid;
the bag fastener being fastened; and
the water receptacle, the shower system, and the utility panel being enclosed by the carrier bag.

8. The shower unit of claim 6, comprising:
wherein the carrier bag is in an open configuration:
the bag fastener being unfastened;
the water receptacle being enclosed by the carrier bag;
the utility panel being exposed through the bag opening; and
the shower head and the second section of the hose being accessible through the bag opening.

9. The shower unit of claim 6, comprising:
a plurality of straps; and
a plurality of fasteners;
the plurality of straps being laterally integrated onto an external surface of the carrier bag; and
each of the plurality of fasteners being engaged with a corresponding strap, wherein the corresponding strap is from the plurality of straps.

10. The shower unit of claim 6, comprising;
a plurality of pockets;
the plurality of pockets being integrated into the carrier bag.

11. The shower unit of claim 1, wherein the water receptacle being insulated.

12. The shower unit of claim 1, wherein the water receptacle being cylindrical.

13. A portable collapsible shower unit comprising:
a water receptacle;
a shower system;
a utility panel;
the water receptacle comprising a first end, a second end, an inner cavity;
the shower system comprising a shower head, a hose and a pump;
the utility panel comprising an actuation button, and a power unit;
the first end being positioned opposite to the second across the water receptacle;
the inner cavity extending from the first end to the second end within the water receptacle;
the utility panel being mounted onto the first end;
the pump being laterally integrated into the utility panel;
the hose comprising a first section, a second section, a third end and a fourth end, wherein the third end is positioned opposite to the fourth end across the hose;
the first section being positioned within the inner cavity;
the second section of the hose being positioned outside the water receptacle;
the third end of the hose penetrating into the inner cavity;
the fourth end of the hose being connected to the shower head;
the pump being operably coupled to the water receptacle, wherein the pump induces a pressure differential that draws water from the inner cavity into the shower head through the hose;
the actuation button being operably coupled to the pump, wherein operating the actuation button controls pumping of water into the shower head; and
the power unit being electrically connected to the pump and the actuation button.

14. The shower unit of claim 13, wherein the water receptacle being compressible, expandable, and insulated.

15. The shower unit of claim 13, wherein the second section of the hose being extendible and retractable.

16. The shower unit of claim 13, comprising:
a fill hole;
a resealable cap;
the fill hole traversing into the water receptacle; and
the resealable cap being engaged with the fill hole.

17. The shower unit of claim 13, comprising:
a carrier bag;
a bag opening;
a lid;
a bag fastener;
the bag opening laterally traversing into the carrier bag;
the lid being terminally connected to the carrier bag adjacent to the bag opening; and
the bag fastener being integrated between an open edge of the carrier bag and the expandable lid.

18. The shower unit of claim 17, comprising:
wherein the carrier bag is in a closed configuration:
the bag opening being covered by the lid;
the bag fastener being fastened; and
the water receptacle, the shower system, and the utility panel being enclosed by the carrier bag.

19. The shower unit of claim 17, comprising:
wherein the carrier bag is in an open configuration:
the bag fastener being unfastened;
the water receptacle being enclosed by the carrier bag;
the utility panel being exposed through the bag opening; and
the shower head and the second section of the hose being accessible through the bag opening.

20. The shower unit of claim 17, comprising:
a plurality of straps; and
a plurality of fasteners;
the plurality of straps being laterally integrated onto an external surface of the carrier bag; and
each of the plurality of fasteners being engaged with a corresponding strap, wherein the corresponding strap is from the plurality of straps.
